(19) United States
(12) Patent Application Publication
(10) Pub. No.: US 2026/0094999 A1
(43) Pub. Date: Apr. 2, 2026

(54) ELECTRICAL CONNECTOR WITH MOVABLE TERMINAL PROTECTION DEVICE

(71) Applicant: DONGGUAN LUXSHARE TECHNOLOGIES CO.,LTD, Dongguan City (CN)

(72) Inventors: Jie ZHANG, Dongguan City (CN); Bin HUANG, Dongguan City (CN); Kunlin YAO, Dongguan City (CN); Hongji CHEN, Dongguan City (CN); Chenhui ZENG, Dongguan City (CN); Shuangfeng YUAN, Dongguan City (CN)

(73) Assignee: DONGGUAN LUXSHARE TECHNOLOGIES CO.,LTD, Dongguan City (CN)

(21) Appl. No.: 18/925,368

(22) Filed: Oct. 24, 2024

(30) Foreign Application Priority Data
Sep. 27, 2024 (CN) 202411365985.8

(51) Int. Cl. H01R 13/6581; H01R 12/72; H01R 12/75; H01R 13/24; H01R 13/514; H01R 13/64

(52) U.S. Cl. CPC H01R 13/6581; H01R 12/721; H01R 12/75; H01R 13/2414; H01R 13/514; H01R 13/64

(57) ABSTRACT

An electrical connector includes a first housing, a first terminal module and a first protection block. The first housing defines a first receiving slot and a first mounting opening. The first terminal module includes a plurality of first conductive terminals. Each first conductive terminal includes a first elastic contact arm. The first elastic contact arm includes a first contact portion and a first distal end portion. The first protection block is at least partially disposed in the first mounting opening. The first protection block defines a first receiving groove in which the first distal end portion is located. The first protection block is configured to be abutted against by a mating module to move away from the first receiving slot.

### CROSS-REFERENCE TO RELATED APPLICATION

This patent application claims priority of a Chinese Patent Application No. 202411365985.8, filed on Sep. 27, 2024 and titled “ELECTRICAL CONNECTOR”, the entire content of which is incorporated herein by reference.

### TECHNICAL FIELD

The present disclosure relates to an electrical connector, which belongs to the technical field of connectors.

### BACKGROUND

An electrical connector in the related art includes an insulating body, a plurality of conductive terminals mounted to the insulating body, and a metal shell mounted on the insulating body. The plurality of conductive terminals include a plurality of signal terminals. The conductive terminal includes an elastic contact arm. The elastic contact arm includes a contact portion and a tail portion integrally extending from the contact portion. However, as the requirements for signal transmission quality of the electrical connector continue to increase, the tail portion will produce significant resonance if it is long in size.

Therefore, there is still room for improvement in the electrical connectors in the related art.

### SUMMARY

An object of the present disclosure is to provide an electrical connector with a movable terminal protection device.

In order to achieve the above object, the present disclosure adopts the following technical solution: an electrical connector, including: a first housing, the first housing defining a first receiving slot, a first terminal module accommodating slot and a first mounting opening located at one end of the first terminal module accommodating slot; the first mounting opening being in communication with the first receiving slot; the first receiving slot being configured to at least partially receive a mating module; a first terminal module, the first terminal module being at least partially disposed in the first terminal module accommodating slot, the first terminal module including a plurality of first conductive terminals, each first conductive terminal including a first elastic contact arm, the first elastic contact arm including a first contact portion protruding into the first receiving slot and a first distal end portion extending from the first contact portion; the first contact portion being configured to contact the mating module; and a first protection block, the first protection block being at least partially disposed in the first mounting opening, the first protection block defining a first receiving groove in which the first distal end portion of the first conductive terminal is located; wherein the first protection block is configured to be abutted against by the mating module after the mating module is inserted into the first receiving slot, so as to move away from the first receiving slot in the first mounting opening.

Compared with the prior art, the electrical connector of the present disclosure includes the first protection block. The first protection block is configured to be abutted against by the mating module so as to move away from the first receiving slot in the first mounting opening after the mating module is inserted into the first receiving slot. With such an arrangement, on the one hand, the resonance can be improved by shortening a length of the first distal end portion, and the quality of signal transmission can be improved. On the other hand, the provision of the first protection block reduces the risk that the first distal end portion is easily damaged by foreign objects after its length is shortened, thereby improving reliability.

### BRIEF DESCRIPTION OF DRAWINGS

FIG. 1 is a perspective schematic view of a connector assembly in accordance with an embodiment of the present disclosure;

FIG. 2 is a perspective view of FIG. 1 from another angle;

FIG. 3 is a partially exploded perspective view of FIG. 1, in which a first module and a second module are separated from each other;

FIG. 4 is a partially exploded perspective view of FIG. 3 from another angle;

FIG. 5 is a partial enlarged view of circled portion B in FIG. 3;

FIG. 6 is a partial enlarged view of circled portion C in FIG. 4;

FIG. 7 is a top view of the first module and the second module when they are separated from each other;

FIG. 8 is a bottom view of FIG. 7;

FIG. 9 is a front view of an electrical connector in FIG. 1;

FIG. 10 is a further partially exploded perspective view of FIG. 3;

FIG. 11 is a further partially exploded perspective view of FIG. 10;

FIG. 12 is a partially exploded perspective view of the first module;

FIG. 13 is a partially exploded perspective view of FIG. 12 from another angle;

FIG. 14 is a partially exploded perspective view of FIG. 12 from yet another angle;

FIG. 15 is a partially exploded perspective view of the second module;

FIG. 16 is a partially exploded perspective view of FIG. 15 from another angle;

FIG. 17 is a partially exploded perspective view of FIG. 15 from yet another angle;

FIG. 18 is a schematic cross-sectional view taken along line D-D in FIG. 9, in which a mating module has just been inserted into a receiving slot;

FIG. 19 is a schematic cross-sectional view taken along line E-E in FIG. 9, in which the mating module has just been inserted into the receiving slot;

FIG. 20 is a schematic cross-sectional view of FIG. 19 after the mating module is fully inserted into the receiving slot;

FIG. 21 is a partial enlarged view of frame portion F in FIG. 19; and

FIG. 22 is a partial enlarged view of frame portion G in FIG. 20.

### DETAILED DESCRIPTION

Exemplary embodiments will be described in detail here, examples of which are shown in drawings. When referring to the drawings below, unless otherwise indicated, same numerals in different drawings represent the same or similar elements. The examples described in the following exemplary embodiments do not represent all embodiments consistent with this application. Rather, they are merely examples of devices and methods consistent with some aspects of the application as detailed in the appended claims.

The terminology used in this application is only for the purpose of describing particular embodiments, and is not intended to limit this application. The singular forms “a”, “said”, and “the” used in this application and the appended claims are also intended to include plural forms unless the context clearly indicates other meanings.

It should be understood that the terms “first”, “second” and similar words used in the specification and claims of this application do not represent any order, quantity or importance, but are only used to distinguish different components. Similarly, “an” or “a” and other similar words do not mean a quantity limit, but mean that there is at least one; “multiple” or “a plurality of” means two or more than two. Unless otherwise noted, “front”, “rear”, “lower” and/or “upper” and similar words are for ease of description only and are not limited to one location or one spatial orientation. Similar words such as “include” or “comprise” mean that elements or objects appear before “include” or “comprise” cover elements or objects listed after “include” or “comprise” and their equivalents, and do not exclude other elements or objects. The term “a plurality of”mentioned in the present disclosure includes two or more.

Hereinafter, some embodiments of the present disclosure will be described in detail with reference to the accompanying drawings. In the case of no conflict, the following embodiments and features in the embodiments can be combined with each other.

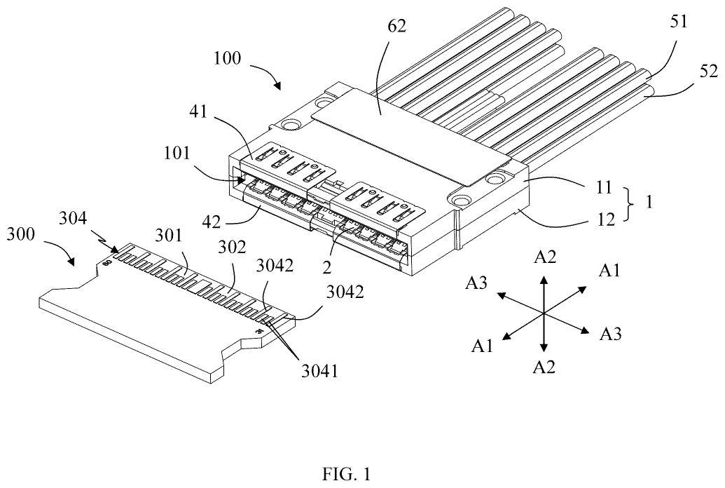

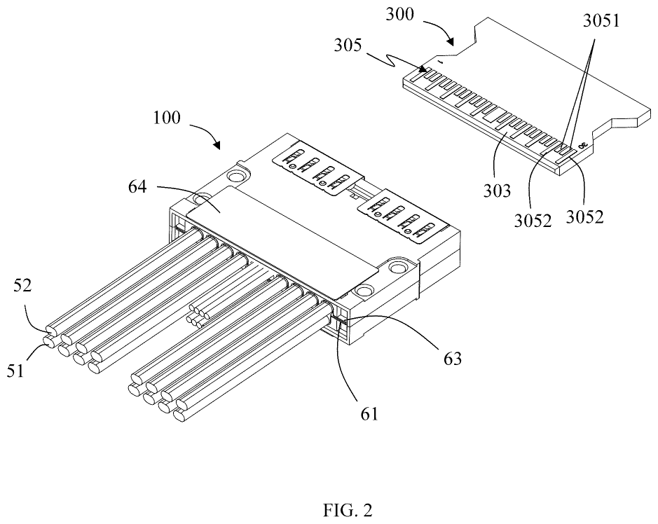

Referring to FIG. 1 and FIG. 2, the present disclosure discloses a connector assembly including an electrical connector 100 and a mating module 300 configured to be at least partially inserted into the electrical connector 100. In the illustrated embodiment of the present disclosure, the electrical connector 100 is an OSFP (Octal Small Form-factor Pluggable) receptacle connector. More specifically, in the illustrated embodiment of the present disclosure, the electrical connector 100 is a receptacle cable connector. Correspondingly, the mating module 300 is an OSFP plug connector. Of course, it is understandable to those skilled in the art that the electrical connector 100 can also be an SFP (Small Form-factor Pluggable) receptacle connector, a QSFP (Quad Small Form-factor Pluggable) receptacle connector, a QSFP-DD (Quad Small Form-factor Pluggable-Double Density) receptacle connector, an SFP-DD (Small Form-factor Pluggable-Double Density) receptacle connector or a DSFP (Dual Chanel Small Form-factor Pluggable) receptacle connector, etc. Correspondingly, the mating module 300 is an SFP plug connector, a QSFP plug connector, a QSFP-DD plug connector, an SFP-DD plug connector or a DSFP plug connector, etc. It is understandable to those skilled in the art that the basic structure of the above types of the electrical connectors is regulated by corresponding association standards, and will not be described in detail here.

Referring to FIG. 1, in the illustrated embodiment of the present disclosure, the electrical connector 100 defines a receiving slot 101 for at least partially receiving the mating module 300. To simplify the description of the specific embodiments of the present disclosure, an insertion and extraction direction of the mating module 300 and the electrical connector 100 is a first direction A1-A1 (for example, a front-rear direction); a thickness direction of the receiving slot 101 is a second direction A2-A2 (for example, a top-bottom direction); a width direction of the receiving slot 101 is a third direction A3-A3 (for example, a left-right direction). Each two of the first direction A1-A1, the second direction A2-A2 and the third direction A3-A3 are perpendicular to each other.

As shown in FIG. 1 and FIG. 2, the mating module 300 includes a tongue plate 301. The tongue plate 301 includes a tongue plate upper surface 302, a tongue plate lower surface 303, a plurality of first contact pads 304 exposed to the tongue plate upper surface 302, and a plurality of second contact pads 305 exposed to the tongue plate lower surface 303. The plurality of first contact pads 304 are disposed at intervals along the third direction A3-A3. The plurality of second contact pads 305 are disposed at intervals along the third direction A3-A3.

Specifically, in the illustrated embodiment of the present disclosure, the plurality of first contact pads 304 include a plurality of first signal contact pads 3041 and a plurality of first ground contact pads 3042. The plurality of first signal contact pads 3041 are divided into a plurality of groups, in which each group includes two first signal contact pads 3041 adjacently arranged along the third direction A3-A3. Each group of first signal contact pads 3041 is associated with two first ground contact pads 3042 which are located on two sides thereof respectively, so as to improve shielding and improve signal transmission quality. In the illustrated embodiment of the present disclosure, each group of first signal contact pads 3041 forms a differential pair to increase the speed of signal transmission. In the illustrated embodiment of the present disclosure, a length of each first ground contact pad 3042 along the first direction A1-A1 is greater than a length of each first signal contact pad 3041 along the first direction A1-A1, so as to better improve the shielding and improve the signal transmission quality.

Similarly, in the illustrated embodiment of the present disclosure, the plurality of second contact pads 305 include a plurality of second signal contact pads 3051 and a plurality of second ground contact pads 3052. The plurality of second signal contact pads 3051 are divided into a plurality of groups, in which each group includes two second signal contact pads 3051 adjacently arranged along the third direction A3-A3. Each group of second signal contact pads 3051 is associated with two second ground contact pads 3052 which are located on two sides thereof respectively, so as to improve shielding and improve signal transmission quality. In the illustrated embodiment of the present disclosure, each group of second signal contact pads 3051 forms a differential pair to increase the speed of signal transmission. In the illustrated embodiment of the present disclosure, a length of each second ground contact pad 3052 along the first direction A1-A1 is greater than a length of each second signal contact pad 3051 along the first direction A1-A1, so as to better improve the shielding and improve the signal transmission quality.

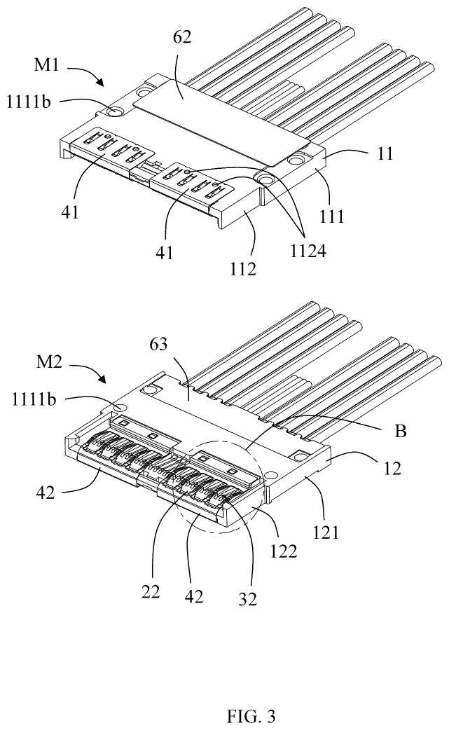

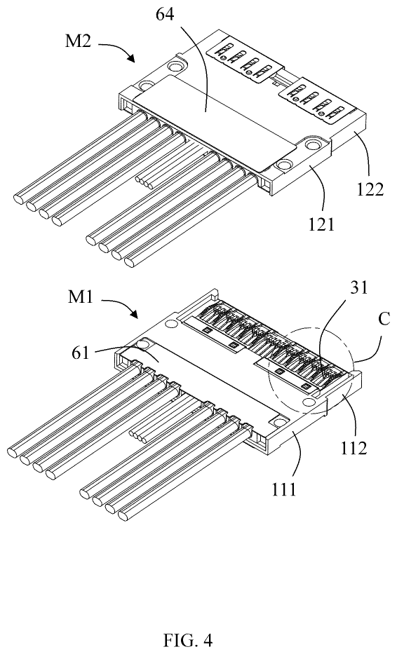

Referring to FIG. 1 to FIG. 4, in the illustrated embodiment of the present disclosure, the electrical connector 100 includes a first module M1 and a second module M2. The first module M1 and the second module M2 are separately arranged and fixed together. Preferably, the first module M1 and the second module M2 are the same part, but have different installation angles to save costs.

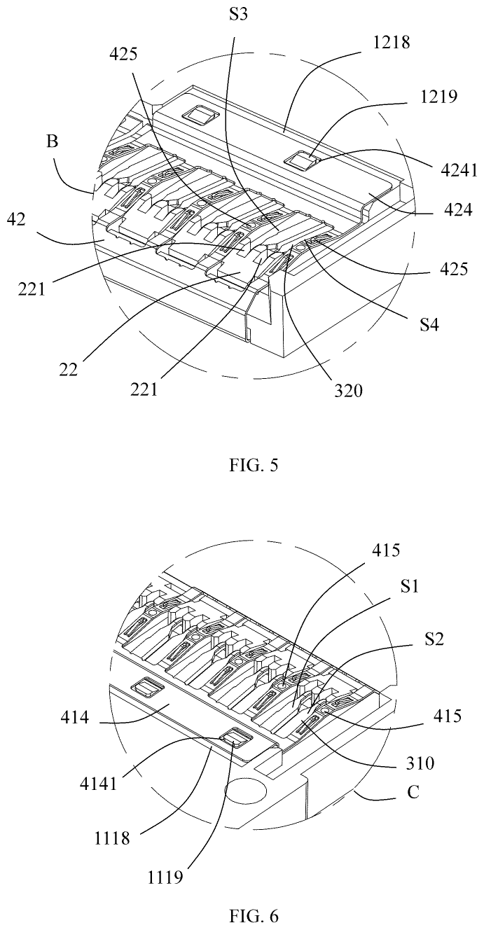

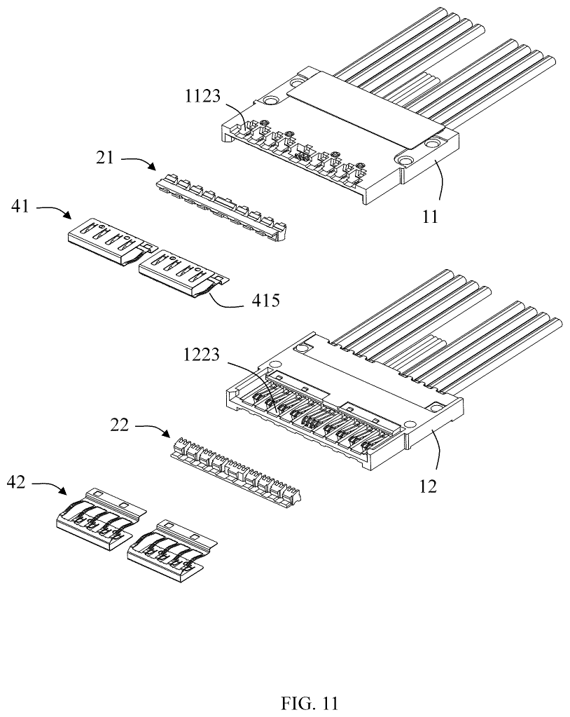

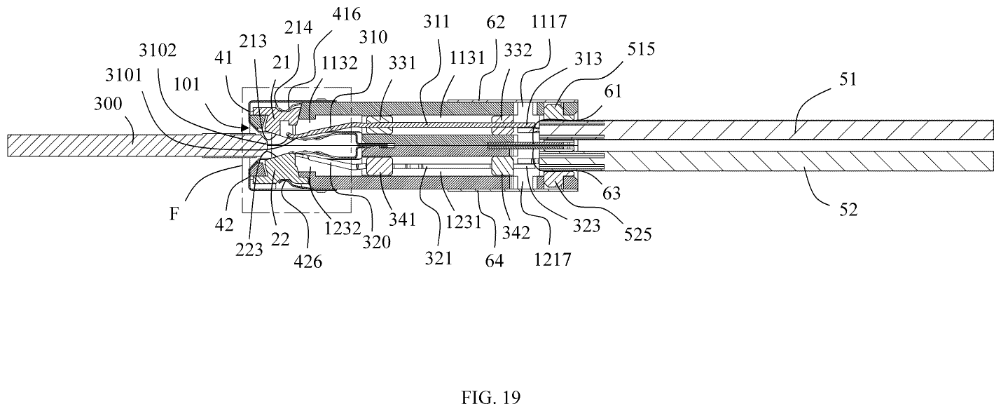

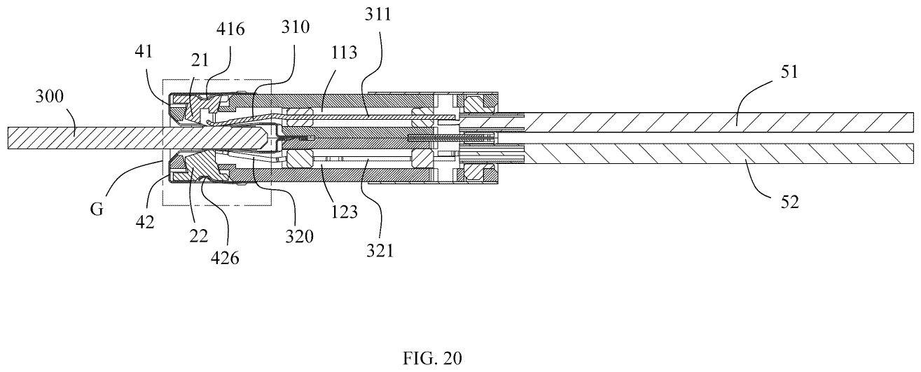

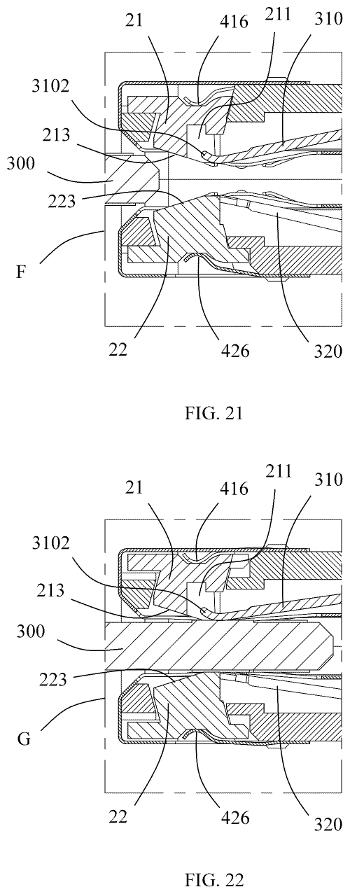

Referring to FIG. 1 to FIG. 22, in one embodiment of the present disclosure, the electrical connector 100 includes a housing 1, a terminal protection device 2 mounted to the housing 1, and a plurality of conductive terminals 3 mounted to the housing 1.

In an embodiment of the present disclosure, the housing 1 is a conductive housing. The conductive housing is a metal housing made of metal material so as to further improve the shielding effect and improve the quality of signal transmission. In another embodiment of the present disclosure, the conductive housing may also be a composite housing formed by electroplating a metal material on an insulating material. The composite housing can also improve the shielding effect and improve the quality of signal transmission.

As shown in FIG. 1 to FIG. 9, in an embodiment of the present disclosure, the housing 1 includes a first housing 11 and a second housing 12. The first housing 11 is a first conductive housing, and the second housing 12 is a second conductive housing. The first housing 11 and the second housing 12 are fixed together. For example, after the first housing 11 and the second housing 12 are assembled, they are fixed together for example by welding or soldering or other methods. In the illustrated embodiment of the present disclosure, the first housing 11 of the first module M1 and the second housing 12 of the second module M2 are separately arranged and fixed together to jointly form the receiving slot 101.

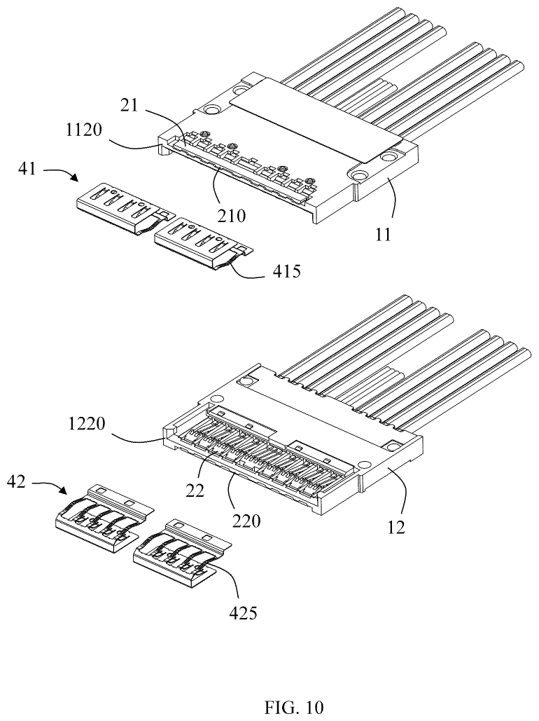

Referring to FIG. 10 to FIG. 14, in an embodiment of the present disclosure, the first housing 11 includes a first base portion 111 and a first protruding portion 112 extending forwardly from the first base portion 111. The first base portion 111 includes a first upper surface 1111, a first lower surface 1112, a first rear surface 1115 and a plurality of first mounting grooves 1116 recessed forwardly from the first rear surface 1115. The plurality of first mounting grooves 1116 are spaced apart along the third direction A3-A3. Besides, the plurality of first mounting grooves 1116 extend downwardly through the first lower surface 1112. In the illustrated embodiment of the present disclosure, the first base portion 111 is further provided with a plurality of first barrier portions 1113. Any two adjacent first mounting grooves 1116 are separated by one first barrier portion 1113 located between the two first mounting grooves 1116 so as to improve the shielding effect and improve the quality of signal transmission. The first base portion 111 further defines a first mounting recess 1110 formed upwardly from the first lower surface 1112, and a plurality of first through holes 1117 communicating with the plurality of first mounting grooves 1116 along the second direction A2-A2. The plurality of first through holes 1117 extend upwardly through the first upper surface 1111. In the illustrated embodiment of the present disclosure, the plurality of first through holes 1117 and the plurality of first mounting grooves 1116 are disposed in a one-to-one correspondence manner, and each first through hole 1117 communicates with a corresponding first mounting groove 1116 along the second direction A2-A2. Specifically, in the illustrated embodiment of the present disclosure, the first mounting grooves 1116 extend backwardly through the first rear surface 1115. The first mounting grooves 1116 communicate downwardly with the first mounting recess 1110. Besides, a bottom of the first base portion 111 further includes at least one first recess 1118 adjacent to the first protruding portion 112. In the illustrated embodiment of the present disclosure, two first recesses 1118 are provided. The first base portion 111 further includes a plurality of first mounting protrusions 1119 protruding into corresponding first recesses 1118.

In addition, the first base portion 111 further defines a plurality of first positioning grooves 1111a extending through the first upper surface 1111 and the first lower surface 1112 along the second direction A2-A2. In the illustrated embodiment of the present disclosure, two first positioning grooves 1111a are provided and spaced apart along the third direction A3-A3. The first base portion 111 further defines a plurality of first fixing holes 1111b extending through the first upper surface 1111 and the first lower surface 1112 along the second direction A2-A2. In the illustrated embodiment of the present disclosure, four first fixing holes 1111b are provided and disposed on two sides of the first base portion 111.

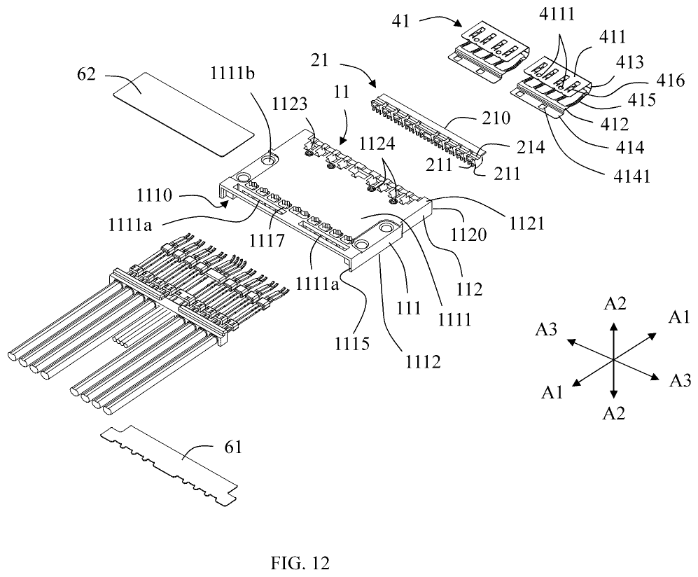

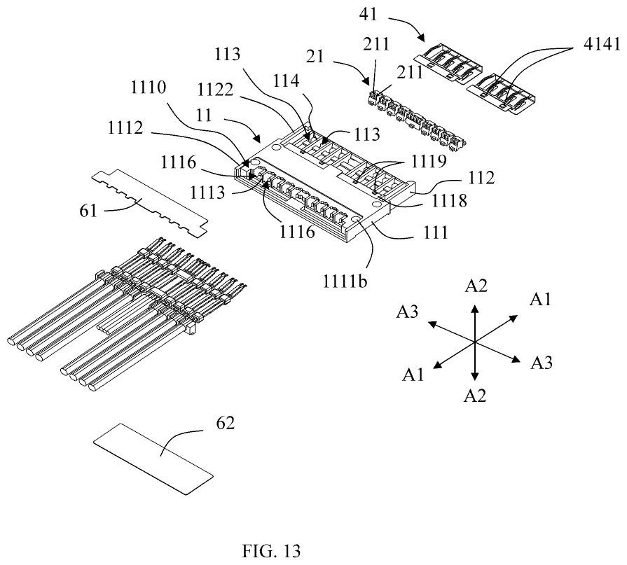

Referring to FIG. 12 and FIG. 13, the first protruding portion 112 includes a second upper surface 1121, a second lower surface 1122, and a plurality of first mounting openings 1123 extending upwardly through the second upper surface 1121 along the second direction A2-A2. The first mounting opening 1123 does not completely extend forwardly through the first front end surface 1120 of the first protruding portion 112 along the first direction A1-A1. In other words, the first protruding portion 112 is provided with a first beam portion 1125 located at a front end of the first mounting opening 1123 to improve the structural strength of the first protruding portion 112. An upper surface of the first beam portion 1125 is lower than the second upper surface 1121 of the first protruding portion 112. The first protruding portion 112 includes a first receiving opening 1126 located above the first beam portion 1125. The first protruding portion 112 further includes a plurality of first positioning posts 1124 protruding upwardly from the second upper surface 1121 along the second direction A2-A2. In addition, the first housing 11 further includes a first receiving slot 101a extending through the first front end surface 1120 along the first direction A1-A1. The first mounting opening 1123 is in communication with the first receiving slot 101a. The first receiving slot 101a is configured to at least partially receive the mating module 300.

Referring to FIG. 13, in the illustrated embodiment of the present disclosure, the first housing 11 further includes a plurality of first terminal module accommodating slots 113 extending along the first direction A1-A1. The first mounting opening 1123 is located at one end (for example, a front end) of the first terminal module accommodating slot 113. Each first terminal module accommodating slot 113 extends from a portion of the first base portion 111 to the first protruding portion 112. A rear end of the first terminal module accommodating slot 113 communicates with the first mounting groove 1116. A middle portion of the first terminal module accommodating slot 113 is circumferentially surrounded by walls of the first housing 11. A front end of the first terminal module accommodating slot 113 extends downwardly through the second lower surface 1122. Specifically, in the illustrated embodiment of the present disclosure, the first terminal module accommodating slot 113 includes a first surrounding groove 1131 close to a corresponding first mounting groove 1116 and a first open slot 1132 away from the corresponding first mounting groove 1116. The first surrounding groove 1131 is surrounded by wall portions of the first housing 11 along a circumferential direction. The first open slot 1132 communicates with the receiving slot 101. It is understandable to those skilled in the art that by arranging the middle portion of the first terminal module accommodating slot 113 to be surrounded by the wall portions of the first housing 11 in a circumferential direction, on the one hand, the conductive terminals located in the first terminal module accommodating slots 113 can be better shielded; and on the other hand, adjacent first terminal module accommodating slots 113 can be well separated, thereby reducing signal crosstalk.

As shown in FIG. 13, the plurality of first terminal module accommodating slots 113 are spaced apart along the third direction A3-A3. The first housing 11 includes a plurality of first partition walls 114 disposed at intervals along the third direction A3-A3. Two adjacent first terminal module accommodating slots 113 are separated by a corresponding first partition wall 114 along the third direction A3-A3. In other words, each first terminal module accommodating slot 113 is surrounded by four walls of the first housing 11 on a length corresponding to the corresponding first partition wall 114, thereby improving the shielding effect. With this arrangement, each first terminal module accommodating slot 113 is relatively independent, thereby reducing signal crosstalk and improving the quality of data transmission.

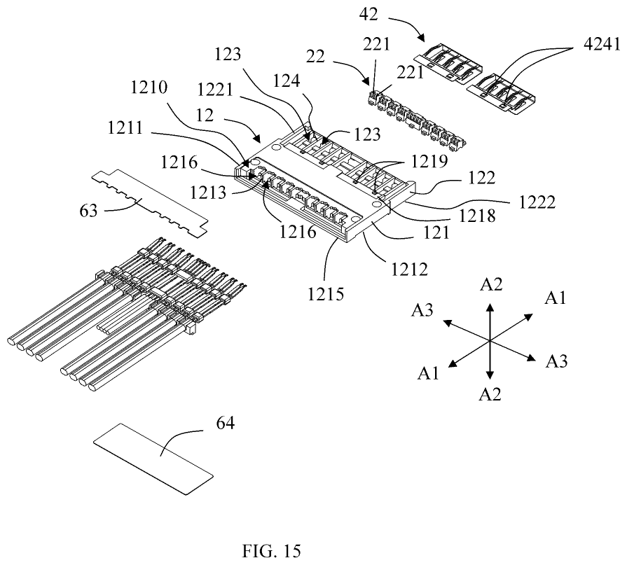

Referring to FIG. 15 to FIG. 17, in an embodiment of the present disclosure, the second housing 12 includes a second base portion 121 and a second protruding portion 122 extending forwardly from the second base portion 121. The second base portion 121 includes a third upper surface 1211, a third lower surface 1212, a second rear surface 1215 and a plurality of second mounting grooves 1216 recessed forwardly from the second rear surface 1215. The plurality of second mounting grooves 1216 are spaced apart along the third direction A3-A3. The plurality of second mounting grooves 1216 extend through the second base portion 121 along the top-bottom direction. The plurality of second mounting grooves 1216 extend upwardly through the third upper surface 1211. In the illustrated embodiment of the present disclosure, the second base portion 121 is further provided with a plurality of second barrier portions 1213. Any two adjacent second mounting grooves 1216 are separated by one second barrier portion 1213 located between the two second mounting grooves 1216 to improve the shielding effect and improve the quality of signal transmission. The second base portion 121 further defines a second mounting recess 1210 formed downwardly from the third upper surface 1211, and a plurality of second through holes 1217 communicating with the plurality of second mounting grooves 1216. The plurality of second through holes 1217 extend downwardly through the third lower surface 1212. In the illustrated embodiment of the present disclosure, the plurality of second through holes 1217 and the plurality of second mounting grooves 1216 are disposed in a one-to-one correspondence manner, and each second through hole 1217 communicates with a corresponding second mounting groove 1216 along the second direction A2-A2. Specifically, in the illustrated embodiment of the present disclosure, the second mounting grooves 1216 extend backwardly through the second rear surface 1215. The second mounting grooves 1216 upwardly communicate with the second mounting recess 1210. The second mounting recess 1210 extends upwardly through the third upper surface 1211. Besides, a top of the second base portion 121 further defines at least one second recess 1218 adjacent to the second protruding portion 122. In the illustrated embodiment of the present disclosure, two second recesses 1218 are provided. The second base portion 121 further includes a plurality of second mounting protrusions 1219 protruding into corresponding second recesses 1218.

In addition, the second base portion 121 further defines a plurality of second positioning grooves 1211a extending through the third upper surface 1211 and the third lower surface 1212 along the second direction A2-A2. In the illustrated embodiment of the present disclosure, two second positioning grooves 1211a are provided and spaced apart along the third direction A3-A3. The second base portion 121 further defines a plurality of second fixing holes 1211b extending through the third upper surface 1211 and the third lower surface 1212 along the second direction A2-A2. In the illustrated embodiment of the present disclosure, four second fixing holes 1211b are provided and disposed on two sides of the second base portion 121. The second fixing holes 1211b are aligned with corresponding first fixing holes 1111b along the second direction A2-A2, which allows fasteners (not shown) to pass through the first fixing holes 1111b and the second fixing holes 1211b so as to fix the first housing 11 and the second housing 12 together.

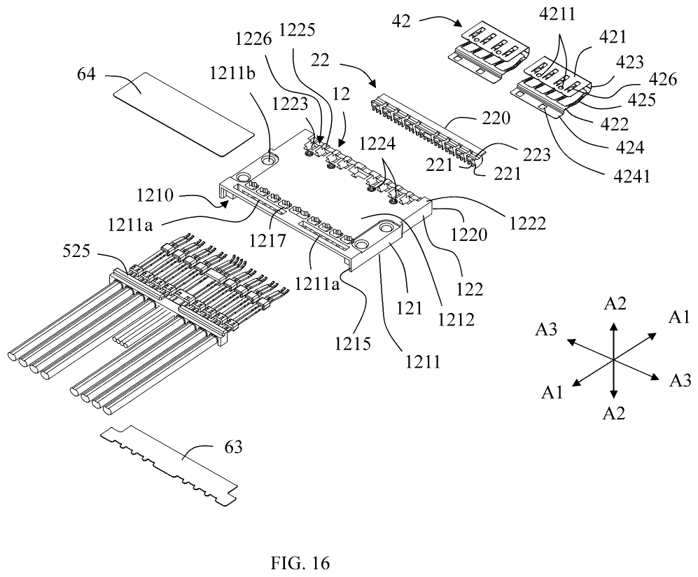

Referring to FIG. 15 and FIG. 16, the second protruding portion 122 includes a fourth upper surface 1221, a fourth lower surface 1222, and a plurality of second mounting openings 1223 extending downwardly through the fourth lower surface 1222. The second mounting opening 1223 does not completely extend forwardly through the second front end surface 1220 of the second protruding portion 122. In other words, the second protruding portion 122 is provided with a second beam portion 1225 located at a front end of the second mounting opening 1223 to improve the structural strength of the second protruding portion 122. A lower surface of the second beam portion 1225 is higher than the fourth lower surface 1222 of the second protruding portion 122. The second protruding portion 122 includes a second receiving opening 1226 located below the second beam portion 1225. The second protruding portion 122 further includes a plurality of second positioning posts 1224 protruding downwardly from the second lower surface 1122. In addition, the second housing 12 further includes a second receiving slot 101b extending through the second front end surface 1220 along the first direction A1-A1. The second mounting opening 1223 is in communication with the second receiving slot 101b. The second receiving slot 101b is configured to at least partially receive the mating module 300.

Referring to FIG. 15, in the illustrated embodiment of the present disclosure, the second housing 12 further includes a plurality of second terminal module accommodating slots 123 extending along the first direction A1-A1. The second mounting opening 1223 is located at one end (for example, a front end) of the second terminal module accommodating slot 123. Each second terminal module accommodating slot 123 extends from the second base portion 121 to the second protruding portion 122. A rear end of the second terminal module accommodating slot 123 communicates with the second mounting groove 1216. The middle portion of the second terminal module accommodating slot 123 is circumferentially surrounded by walls of the second housing 12. A front end of the second terminal module accommodating slot 123 extends upwardly through the fourth upper surface 1221. Specifically, in the illustrated embodiment of the present disclosure, the second terminal module accommodating slot 123 includes a second surrounding groove 1231 close to a corresponding second mounting groove 1216 and a second open slot 1232 away from the corresponding second mounting groove 1216. The second surrounding groove 1231 is surrounded by wall portions of the second housing 12 along a circumferential direction. The second open slot 1232 communicates with the receiving slot 101. It is understandable to those skilled in the art that by arranging the middle portion of the second terminal module accommodating slot 123 to be surrounded by the wall portions of the second housing 12 in a circumferential direction; on the one hand, the conductive terminals located in the second terminal module accommodating slots 123 can be better shielded; and on the other hand, the adjacent second terminal module accommodating slots 123 can be well separated, thereby reducing signal crosstalk.

As shown in FIG. 15, the plurality of second terminal module accommodating slots 123 are arranged at intervals along the third direction A3-A3. The second housing 12 includes a plurality of second partition walls 124 disposed at intervals along the third direction A3-A3. Two adjacent second terminal module accommodating slots 123 are separated by corresponding second partition walls 124 along the third direction A3-A3. In other words, each second terminal module accommodating slot 123 is surrounded by four walls of the second housing 12 on a length corresponding to the second partition wall 124, thereby improving the shielding effect. With this arrangement, each second terminal module accommodating slot 123 is relatively independent, thereby reducing signal crosstalk and improving the quality of data transmission.

Referring to FIG. 10 to FIG. 14, in the illustrated embodiment of the present disclosure, the terminal protection device 2 includes a first protection block 21 and a second protection block 22. The first protection block 21 is a first insulating protection block. The second protection block 22 is a second insulating protection block. The first protection block 21 is mounted in the first mounting opening 1123 and is movable in the first mounting opening 1123. The second protection block 22 is mounted in the second mounting opening 1223 and is movable in the second mounting opening 1223.

The first protection block 21 includes a first support portion 215 received in the first receiving opening 1126. The first protection block 21 further defines a plurality of first receiving grooves 211. The plurality of first receiving grooves 211 are spaced apart along the third direction A3-A3. Each adjacent two of the plurality of first receiving grooves 211 form a group and correspond to the corresponding first terminal module accommodating slot 113. The first protection block 21 further includes a first front surface 210 which is coplanar with the first front end surface 1120 of the first protruding portion 112.

Similarly, as shown in FIG. 15 to FIG. 17, the second protection block 22 includes a second support portion 225 received in the second receiving opening 1226. The second protection block 22 further defines a plurality of second receiving grooves 221. The plurality of second receiving grooves 221 are spaced apart along the third direction A3-A3. Each adjacent two of the plurality of second receiving grooves 221 form a group and correspond to the corresponding second terminal module accommodating slot 123. The second protection block 22 includes a second front surface 220 which is coplanar with the second front end surface 1220 of the second protruding portion 122.

As shown in FIG. 10 to FIG. 14, the plurality of conductive terminals 3 include a plurality of first conductive terminals 31 and a plurality of second conductive terminals 32. Each first conductive terminal 31 includes a first fixing portion 311 extending along the first direction A1-A1, a first elastic contact arm 310 extending forwardly from a front end of the first fixing portion 311, and a first tail portion 313 extending backwardly from a rear end of the first fixing portion 311. The first fixing portion 311 is at least partially located in the first surrounding groove 1131. The first elastic contact arm 310 is at least partially located in the first open slot 1132. The first tail portion 313 is at least partially located in the first mounting groove 1116. The first elastic contact arm 310 includes a first contact portion 3101 that passes through the first open slot 1132 and extends into the first receiving slot 101a. The first contact portions 3101 are configured to be in contact with the first signal contact pads 3041 of the tongue plate 301. In the illustrated embodiment of the present disclosure, the first tail portions 313 extend backwardly and horizontally to be electrically connected to first cables 51. In addition, the first elastic contact arm 310 further includes a first distal end portion 3102 extending from the first contact portion 3101. The first distal end portion 3102 of the first conductive terminal 31 is located in the first receiving groove 211. In the illustrated embodiment of the present disclosure, a length of the first distal end portion 3102 is short in order to improve resonance and improve the quality of signal transmission. Besides, the provision of the first protection block 21 reduces the risk that the first distal end portion 3102 is easily damaged by foreign objects after its length is shortened, thereby improving reliability. Preferably, in the illustrated embodiment of the present disclosure, the first distal end portion 3102 is located in the first receiving groove 211 no matter what state the first protection block 21 is in. The first protection block 21 is able to protect the first distal end portion 3102, thereby reducing the risk of the first distal end portion 3102 being damaged by foreign objects.

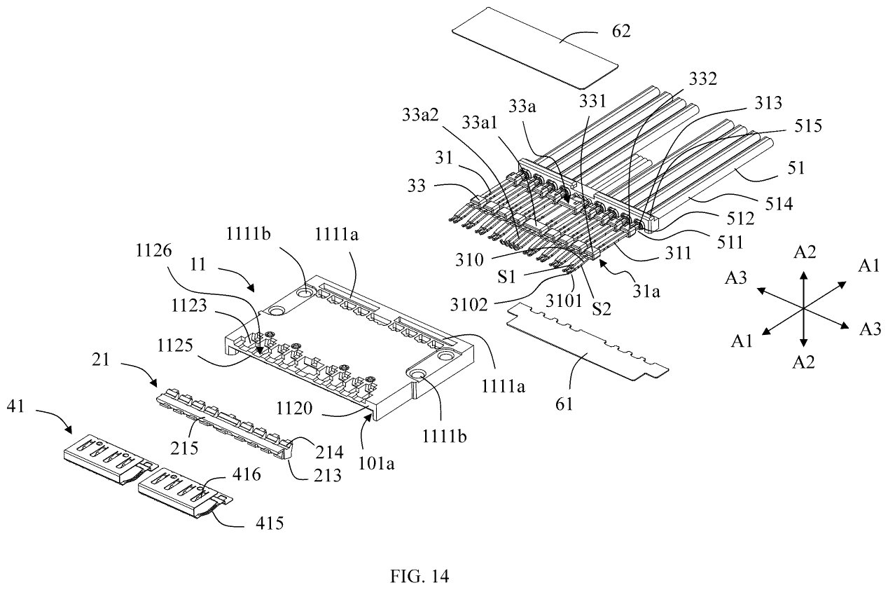

Referring to FIG. 14, in the illustrated embodiment of the present disclosure, the plurality of first conductive terminals 31 are divided into a plurality of groups. Each group of first conductive terminals 31 includes a first signal terminal S1 and a second signal terminal S2 located adjacent to the first signal terminal S1. Preferably, the first signal terminal S1 and the second signal terminal S2 in each group of first conductive terminals 31 form a differential pair to improve signal transmission speed, thereby being suitable for high-speed signal transmission.

In the illustrated embodiment of the present disclosure, the electrical connector 100 further includes a first holding block 33 fixed on the first signal terminal S1 and the second signal terminal S2 of each group of first conductive terminals 31. In an embodiment of the present disclosure, the first signal terminal S1 and the second signal terminal S2 are insert-molded with the first holding block 33, so as to form an integrated first terminal module 31a. The first contact portions 3101 of the first signal terminal S1 and the second signal terminal S2 in each first terminal module 31a are configured to be in contact with the first signal contact pads 3041 of the mating module 300, respectively. The first terminal module 31a is at least partially disposed (for example, assembled) in the first terminal module accommodating slot 113.

In the illustrated embodiment of the present disclosure, the first holding block 33 includes a first fixing block 331 fixed on middle portions of the first fixing portions 311 of the first signal terminal S1 and the second signal terminal S2, and a second fixing block 332 fixed on rear ends of the first fixing portions 311 of the first signal terminal S1 and the second signal terminal S2. The first fixing block 331 and the second fixing block 332 are installed and fixed in the first terminal module accommodating slot 113, which prevents the first conductive terminal 31 from contacting the first housing 11 to cause a short circuit. The first tail portion 313 extends backwardly into the first mounting groove 1116 to facilitate connection with the first cable 51.

Similarly, referring to FIG. 15 to FIG. 17, each second conductive terminal 32 includes a second fixing portion 321 extending along the first direction A1-A1, a second elastic contact arm 320 extending forwardly from a front end of the second fixing portion 321, and a second tail portion 323 extending backwardly from a rear end of the second fixing portion 321. The second fixing portion 321 is at least partially located in the second surrounding groove 1231. The second elastic contact arm 320 is located at least partially in the second open slot 1232. The second tail portion 323 is at least partially located in the second mounting groove 1216. The second elastic contact arm 320 includes a second contact portion 3201 that passes through the second open slot 1232 and extends into the second receiving slot 101b. The second contact portions 3201 are configured to be in contact with the second signal contact pads 3051 of the tongue plate 301. In the illustrated embodiment of the present disclosure, the second tail portions 323 extend backwardly and horizontally from the second fixing portions 321 to be electrically connected to second cables 52. In addition, the second elastic contact arm 320 further includes a second distal end portion 3202 extending from the second contact portion 3201. The second distal end portion 3202 of the second conductive terminal 32 is located in the second receiving groove 221. In the illustrated embodiment of the present disclosure, a length of the second distal end portion 3202 is short in order to improve resonance and improve the quality of signal transmission. Besides, the provision of the second protection block 22 reduces the risk that the second distal end portion 3202 is easily damaged by foreign objects after its length is shortened, thereby improving reliability. Preferably, in the illustrated embodiment of the present disclosure, the second distal end portion 3202 is located in the second receiving groove 221 no matter what state the second protection block 22 is in. The second protection block 22 is able to protect the second distal end portion 3202, thereby reducing the risk of the second distal end portion 3202 being damaged by foreign objects.

In the illustrated embodiment of the present disclosure, the plurality of second conductive terminals 32 are divided into a plurality of groups, and each group of second conductive terminals 32 includes a third signal terminal S3 and a fourth signal terminal S4 located adjacent to the third signal terminal S3. Preferably, the third signal terminal S3 and the fourth signal terminal S4 in each group of second conductive terminals 32 form a differential pair to improve signal transmission speed, thereby being suitable for high-speed signal transmission.

In the illustrated embodiment of the present disclosure, the electrical connector 100 further includes a second holding block 34 fixed on the third signal terminal S3 and the fourth signal terminal S4 of each group of second conductive terminals 32. In one embodiment of the present disclosure, the third signal terminal S3 and the fourth signal terminal S4 are insert-molded with the second holding block 34 to form an integrated second terminal module 32a. The second contact portions 3201 of the third signal terminal S3 and the fourth signal terminal S4 in each second terminal module 32a are configured to be in contact with the second signal contact pads 3051 of the mating module 300. The second terminal module 32a is at least partially disposed (for example, assembled) in the second terminal module accommodating slot 123.

In the illustrated embodiment of the present disclosure, the second holding block 34 includes a third fixing block 341 fixed at middle portions of the second fixing portions 321 of the third signal terminal S3 and the fourth signal terminal S4, and a fourth fixing block 342 fixed at rear ends of the second fixing portions 321 of the third signal terminal S3 and the fourth signal terminal S4. The third fixing block 341 and the fourth fixing block 342 are installed and fixed in the second terminal module accommodating slot 123, which prevents the second conductive terminal 32 from contacting the second housing 12 to cause a short circuit. The second tail portions 323 extend backwardly into the second mounting grooves 1216 to facilitate connection with the second cables 52.

In the illustrated embodiment of the present disclosure, the first protection block 21 is configured to be abutted against by the mating module 300 after the mating module 300 is inserted into the first receiving slot 101a, so as to move away from the first receiving slot 101a in the first mounting opening 1123. Similarly, the second protection block 22 is configured to be abutted against by the mating module 300 so as to move away from the second receiving slot 101b in the second mounting opening 1223. In the illustrated embodiment of the present disclosure, the first protection block 21 and the second protection block 22 are movable along the second direction A2-A2. Of course, it is understandable to those skilled in the art that in other embodiments of the present disclosure, the first protection block 21 and the second protection block 22 can also be tilted to move away from the first receiving slot 101a and the second receiving slot 101b, respectively.

Specifically, in the illustrated embodiment of the disclosure, the first protection block 21 is provided with a first guide surface 213 exposed in the first receiving slot 101a. The first guide surface 213 is configured to guide the mating module 300 to be inserted into the first receiving slot 101a. In the illustrated embodiment of the present disclosure, the first guide surface 213 is a first inclined surface. The first receiving groove 211 extends downwardly through the first guide surface 213. Besides, the first protection block 21 further defines a first notch 214 that is recessed downwardly from its upper surface.

In the illustrated embodiment of the present disclosure, the second protection block 22 is provided with a second guide surface 223 exposed in the second receiving slot 101b. The second guide surface 223 is configured to guide the mating module 300 to be inserted into the second receiving slot 101b. In the illustrated embodiment of the present disclosure, the second guide surface 223 is a second inclined surface. The second receiving groove 221 extends upwardly through the second guide surface 223. Besides, the second protection block 22 further defines a second notch 224 that is recessed upwardly from its lower surface.

In the illustrated embodiment of the present disclosure, the first guide surface 213 and the second guide surface 223 jointly form a bell mouth to guide the mating module 300 to be inserted into the receiving slot 101.

As shown in FIG. 14, in the illustrated embodiment of the present disclosure, the electrical connector 100 further includes a first non-high-speed terminal module 33a and a second non-high-speed terminal module 34a. The first non-high-speed terminal module 33a includes a first insulating block 33a1 and a plurality of first non-high-speed terminals 33a2 fixed to the first insulating block 33a1. It is understandable to those skilled in the art that the first non-high-speed terminals 33a2 include but are not limited to non-high-speed signal terminals, power terminals, etc.

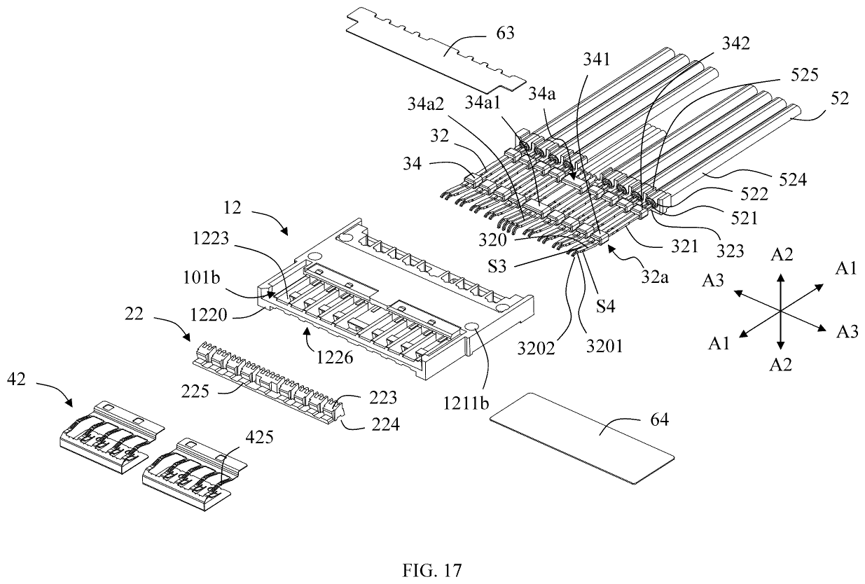

Similarly, as shown in FIG. 17, the second non-high-speed terminal module 34a includes a second insulating block 34a1 and a plurality of second non-high-speed terminals 34a2 fixed to the second insulating block 34a1. It is understandable to those skilled in the art that the second non-high-speed terminals 34a2 include but are not limited to non-high-speed signal terminals, power terminals, etc.

Referring to FIG. 14, in the illustrated embodiment of the present disclosure, the first cable 51 includes a first core 511, a first insulator 512 wrapped around the first core 511, and a first insulating skin 514 wrapped around the outermost side. In the illustrated embodiment of the present disclosure, the first module M1 further includes a first mounting block 515 fixed on the first cables 51. The first mounting block 515 combines all the first cables 51 into a whole. The first mounting block 515 is fixed in the first positioning groove 1111a.

Similarly, as shown in FIG. 17, the second cable 52 includes a second core 521, a second insulator 522 wrapped around the second core 521, and a second insulating skin 524 wrapped around the outermost side. In the illustrated embodiment of the present disclosure, the second module M2 further includes a second mounting block 525 fixed on the second cables 52. The second mounting block 525 combines all the second cables 52 into a whole. The second mounting block 525 is fixed in the second positioning groove 1211a.

Referring to FIG. 1 to FIG. 22, in one embodiment of the present disclosure, the electrical connector 100 further includes at least one ground sheet 4 mounted to the housing 1. The ground sheet 4 includes a first ground sheet 41 and a second ground sheet 42. In the illustrated embodiment of the present disclosure, two first ground sheets 41 are provided and they are made of metal material. Two second ground sheets 42 are provided and they are made of metal material.

Referring to FIG. 12 and FIG. 13, each first ground sheet 41 is generally U-shaped and includes a first mounting plate 411, a second mounting plate 412 opposite to the first mounting plate 411, a first connecting plate 413 connecting one side of the first mounting plate 411 and one side of the second mounting plate 412, and a first extension plate 414 extending downwardly and backwardly from another side of the second mounting plate 412. The first mounting plate 411 defines a plurality of first mounting positioning holes 4111 that match the first positioning posts 1124. The first extension plate 414 is received in a corresponding first recess 1118 of the first housing 11. The first extension plate 414 defines a plurality of first mounting holes 4141 to receive the first mounting protrusions 1119.

The first connecting plate 413 abuts against and at least partially covers the first front surface 210 of the first protection block 21. The first connecting plate 413 is located at a front end of the receiving slot 101 along the first direction A1-A1. When the mating module 300 is inserted, the tongue plate 301 may be in contact with the first connecting plate 413 first, thereby facilitating the discharge of static electricity. The first ground sheet 41 includes a plurality of first abutting elastic arms 416 that abut against the first protection block 21. The first abutting elastic arm 416 is configured to provide a restoring force to the first protection block 21. In the illustrated embodiment of the present disclosure, the first abutting elastic arms 416 are integrally stamped from the first mounting plate 411. The first abutting elastic arm 416 extends into the first notch 214 to abut against the first protection block 21. The second mounting plate 412 is provided with a plurality of first grounding elastic arms 415 which are disposed at intervals along the third direction A3-A3. The first grounding elastic arms 415 are disposed on two sides of the first elastic contact arms 310 of each group of first conductive terminals 31 so as to improve the shielding effect and improve the quality of signal transmission.

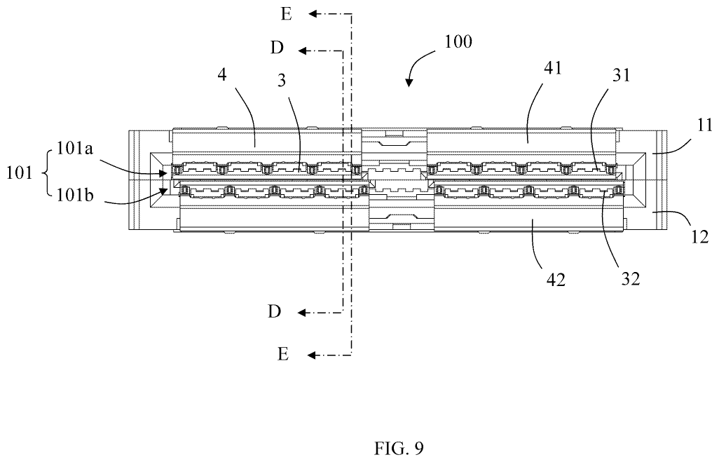

In an embodiment of the present disclosure, the first positioning posts 1124 are fixed to the first mounting positioning holes 4111, so that the first mounting plate 411 is fixed to the second upper surface 1121 of the first protruding portion 112. As shown in FIG. 8, a dimension of the first mounting hole 4141 along the first direction A1-A1 may be slightly larger than a dimension of the first mounting protrusion 1119 along the first direction A1-A1. Therefore, when the first grounding elastic arms 415 are contacted and deformed by the first ground contact pad 3042 of the mating module 300, the first extension plate 414 can move appropriately in the first recess 1118 along the first direction A1-A1.

Referring to FIG. 15 to FIG. 17, each second ground sheet 42 is generally U-shaped and includes a third mounting plate 421, a fourth mounting plate 422 opposite to the third mounting plate 421, a second connecting plate 423 connecting one side of the third mounting plate 421 and one side of the fourth mounting plate 422, and a second extension plate 424 extending downwardly and backwardly from another side of the fourth mounting plate 422. The third mounting plate 421 defines a plurality of second mounting positioning holes 4211 that match the second positioning posts 1224. The second extension plate 424 is received in a corresponding second recess 1218 of the second housing 12. The second extension plate 424 defines a plurality of second mounting holes 4241 to receive the second mounting protrusions 1219.

The second connecting plate 423 abuts against and at least partially covers the second front surface 220 of the second protection block 22. The second connecting plate 423 is located at the front end of the receiving slot 101 along the first direction A1-A1. When the mating module 300 is inserted, the tongue plate 301 may be in contact with the second connecting plate 423 first, thereby facilitating the discharge of static electricity. The second ground sheet 42 includes a plurality of second abutting elastic arms 426 that abut against the second protection block 22. The second abutting elastic arm 426 is configured to provide a restoring force to the second protection block 22. In the illustrated embodiment of the present disclosure, the second abutting elastic arms 426 are integrally stamped from the third mounting plate 421. The second abutting elastic arm 426 extends into the second notch 224 to abut against the second protection block 22. The fourth mounting plate 422 is provided with a plurality of second grounding elastic arms 425 which are disposed at intervals along the third direction A3-A3. The second grounding elastic arms 425 are disposed on two sides of the second elastic contact arms 320 of each group of second conductive terminals 32, respectively, so as to improve the shielding effect and improve the quality of signal transmission.

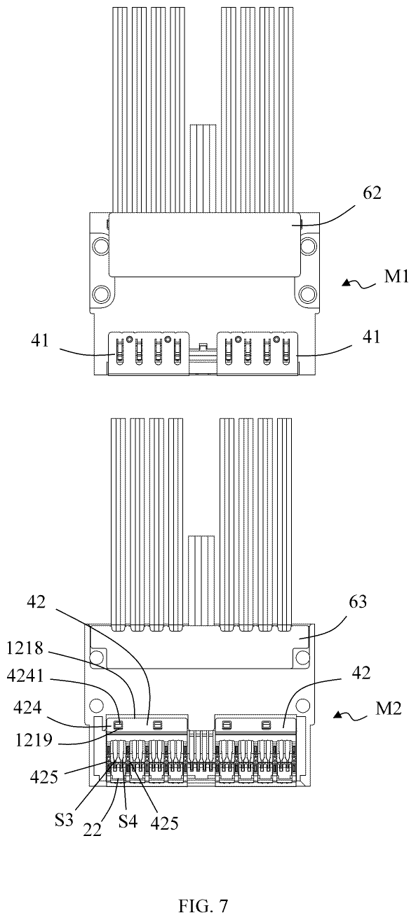

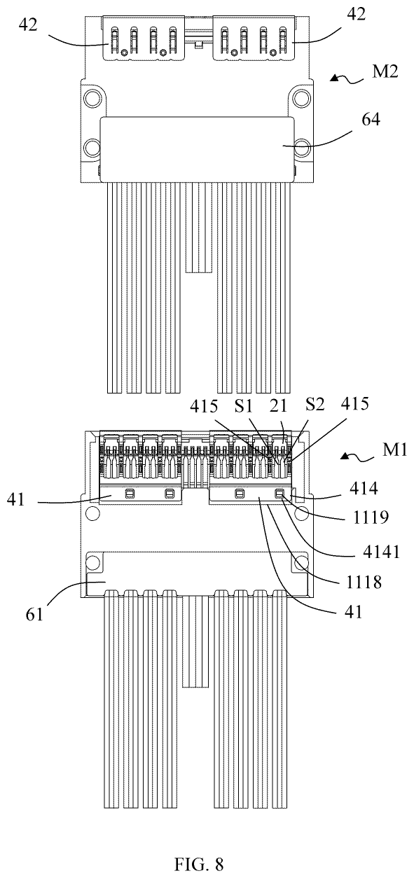

In an embodiment of the present disclosure, the second positioning posts 1224 are fixed in the second mounting positioning holes 4211, so that the third mounting plate 421 is fixed to the fourth lower surface 1222 of the second protruding portion 122. As shown in FIG. 7, a dimension of the second mounting hole 4241 along the first direction A1-A1 may be slightly larger than a dimension of the second mounting bump 1219 along the first direction A1-A1. Therefore, when the second grounding elastic arms 425 are contacted and deformed by the second ground contact pad 3052 of the mating module 300, the second extension plate 424 can move appropriately in the second recess 1218 along the first direction A1-A1.

Referring to FIG. 10 to FIG. 14, in the illustrated embodiment of the present disclosure, the first module M1 further includes a first shielding plate 61 installed on the first housing 11 and a first shielding cover 62 installed on the first housing 11. In an embodiment of the present disclosure, the first shielding plate 61 is a metal shielding plate, and the first shielding cover 62 is a metal shielding cover. The first shielding plate 61 is installed in the first mounting recess 1110. By installing the first shielding plate 61, the downwardly open first mounting grooves 1116 can be better shielded, thereby improving the shielding effect.

The first shielding cover 62 is fixed to the first housing 11 to cover the first through holes 1117, thereby improving the shielding effect.

Referring to FIG. 15 to FIG. 17, in the illustrated embodiment of the present disclosure, the second module M2 further includes a second shielding plate 63 installed on the second housing 12 and a second shielding cover 64 installed on the second housing 12. In an embodiment of the present disclosure, the second shielding plate 63 is a metal shielding plate, and the second shielding cover 64 is a metal shielding cover. The second shielding plate 63 is installed in the second mounting recess 1210. By installing the second shielding plate 63, the downwardly open second mounting grooves 1216 can be better shielded, thereby improving the shielding effect.

The second shielding cover 64 is fixed to the second housing 12 to cover the second through holes 1217, thereby improving the shielding effect.

When assembling the electrical connector 100, firstly, the first protection block 21 is mounted in the first mounting opening 1123, and the second protection block 22 is mounted in the second mounting opening 1223.

Then, the first terminal modules 31a and the second terminal modules 32a are installed in the corresponding first terminal module accommodating slots 113 and the second terminal accommodating slots 123 from back to front along the first direction A1-A1. At this time, the first fixing block 331 and the second fixing block 332 are fixed in the corresponding first terminal module accommodating slot 113, the first fixing portions 311 of the first conductive terminals 31 are disposed overhead in the corresponding first terminal module accommodating slot 113, in order to avoid short circuit due to contact with the first housing 11. The first distal end portion 3102 of the first signal terminal S1 and the first distal end portion 3102 of the second signal terminal S2 both at least partially extend into the first receiving grooves 211 of the first protection block 21. Similarly, the third fixing block 341 and the fourth fixing block 342 are installed in the corresponding second terminal module accommodating slot 123, the second fixing portions 321 of the second conductive terminal 32 are disposed overhead in the second terminal module accommodating slot 123, in order to avoid short circuit due to contact with the second housing 12. The second distal end portion 3202 of the third signal terminal S3 and the second distal end portion 3202 of the fourth signal terminal S4 both at least partially extend into the second receiving grooves 221 of the second protection block 22. At this time, the first tail portion 313 of the first conductive terminal 31 is backwardly exposed in the first mounting groove 1116, and the second tail portion 323 of the second conductive terminal 32 is backwardly exposed in the second mounting groove 1216.

Then, the first cables 51 and the second cables 52 are inserted into the corresponding first mounting grooves 1116 and the second mounting grooves 1216 from back to front along the first direction A1-A1. Alternatively, the first cables 51 and the second cables 52 can be disposed in the corresponding first mounting grooves 1116 and the corresponding second mounting grooves 1216 along the second direction A2-A2. The first core 511 of the first cable 51 is in contact with the first tail portion 313 of the first conductive terminal 31. The second core 521 of the second cable 52 is in contact with the second tail portion 323 of the second conductive terminal 32.

In the illustrated embodiment of the present disclosure, the first cables 51 and the second cables 52 are inserted into the corresponding first mounting grooves 1116 and the second mounting grooves 1216 from back to front along the first direction A1-A1. The first core 511 of the first cable 51 is located at a bottom of the first tail portion 313 of the first conductive terminal 31. The second core 521 of the second cable 52 is located on a top of the second tail portion 323 of the second conductive terminal 32. Preferably, in an embodiment of the present disclosure, the first core 511 of the first cable 51 and the first tail 313 of the first conductive terminal 31 are fixed by soldering or welding. The second core 521 of the second cable 52 and the second tail 323 of the second conductive terminal 32 are fixed by soldering or welding.

In order to better perform soldering or welding, in one embodiment of the present disclosure, a first clamp tool (not shown) is provided to extend into the first mounting recess 1110 to support the first cable 51; a second clamp tool (not shown) is provided and inserted into the first through hole 1117 along the second direction A2-A2 to abut against the first tail portion 313 of the first conductive terminal 31. At this time, the first tail portion 313 of the first conductive terminal 31 and the first core 511 of the first cable 51 are clamped between the first clamp tool and the second clamp tool. Therefore, the contact reliability between the first tail portion 313 of the first conductive terminal 31 and the first core 511 of the first cable 51 is improved, and the soldering or welding yield can be improved.

Similarly, in order to better perform soldering or welding, in one embodiment of the present disclosure, a third clamp tool (not shown) is provided and extends into the second mounting recess 1210 to support the second cable 52; and a fourth clamp tool (not shown) is provided and inserted into the second through hole 1217 along the second direction A2-A2 to abut against the second tail portion 323 of the second conductive terminal 32. At this time, the second tail portion 323 of the second conductive terminal 32 and the second core 521 of the second cable 52 are clamped between the third clamp tool and the fourth clamp tool. Therefore, the contact reliability between the second tail portion 323 of the second conductive terminal 32 and the second core 521 of the second cable 52 is improved, and the soldering or welding yield can be improved.

After the soldering or welding process is completed, the first clamp tool, the second clamp tool, the third clamp tool and the fourth clamp tool are removed.

Then, the first mounting block 515 and the second mounting block 525 are mounted on the first cables 51 and the second cables 52, respectively.

Then, the first shielding plate 61 and the first shielding cover 62 are installed on the first housing 11; and the second shielding plate 63 and the second shielding cover 64 are installed on the second housing 12. The first shielding plate 61 replaces the first clamp tool and fills the position of the first clamp tool during the soldering or welding process of the first cable 51 and the first conductive terminal 31, which avoids the impact of losing supporting to the first cable 51 due to removal of the first clamp tool. The first shielding cover 62 is fixed to the first housing 11 to cover the first through holes 1117, thereby improving the shielding effect.

Similarly, the second shielding plate 63 replaces the third clamp tool and fills the position of the third clamp tool during the soldering or welding process of the second cable 52 and the second conductive terminal 32, which avoids the impact of losing supporting to the second cable 52 due to removal of the third clamp tool. The second shielding cover 64 is fixed to the second housing 12 to cover the second through holes 1217, thereby improving the shielding effect.

Then, the first ground sheet 41 and the second ground sheet 42 are installed on the first housing 11 and the second housing 12, respectively.

Then, the first housing 11 and the second housing 12 are attached to each other. The first base portion 111 and the second base portion 121 correspond along the top-bottom direction. The first protruding portion 112 and the second protruding portion 122 correspond along the top-bottom direction. The first shielding plate 61 and the second shielding plate 63 are in contact with each other to share a grounding area and improve the grounding shielding effect. In the second direction A2-A2, the first shielding plate 61 and the second shielding plate 63 are located between the plurality of first conductive terminals 31 and the plurality of second conductive terminals 32 to reduce crosstalk between the first conductive terminals 31 and the second conductive terminals 32. Fasteners (not shown) are provided to pass through the first fixing holes 1111b and the second fixing holes 1211b to fix the first housing 11 and the second housing 12 together. Besides, in order to further increase the bonding force of the first housing 11 and the second housing 12, the first housing 11 and the second housing 12 are soldered or welded at the joining position. When the first housing 11 and the second housing 12 are fixed, the receiving slot 101 for receiving the mating module 300 is formed between the first protruding portion 112 and the second protruding portion 122. The receiving slot 101 includes the first receiving slot 101a and the second receiving slot 101b.

It is understandable to those skilled in the art that the order of the steps in the above assembly method can be flexibly adjusted as needed, and will not be described again in the present disclosure.

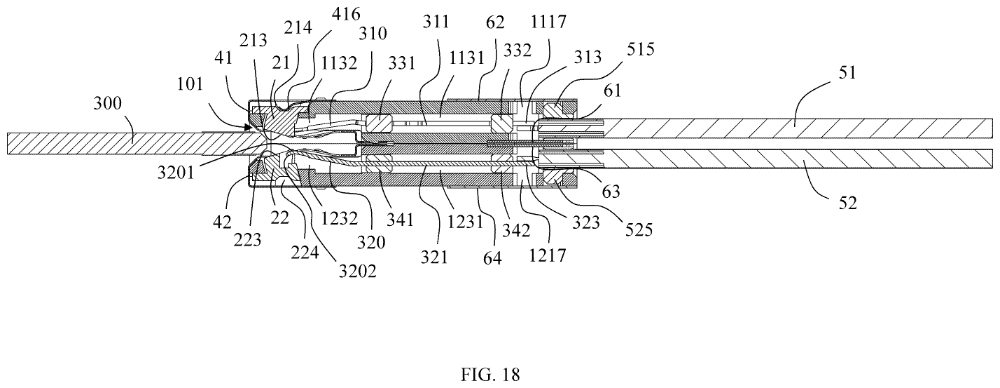

Referring to FIG. 18 to FIG. 22, when in use, the mating module 300 is at least partially inserted into the receiving slot 101. The tongue plate 301 of the mating module 300 is inserted into the receiving slot 101 under the guidance of the first guide surface 213 and the second guide surface 223. When the tongue plate 301 is inserted into the receiving slot 101, it will abut against the first protection block 21 upwardly along the second direction A2-A2, and abut against the second protection block 22 downwardly along the second direction A2-A2. The first protection block 21 and the second protection block 22 respectively move upwardly in the first mounting opening 1123 and move downwardly in the second mounting opening 1223 along the second direction A2-A2, thereby moving away from the receiving slot 101 and giving way. Finally, the tongue plate 301 can be successfully inserted in place.

During the movement, the first protection block 21 and the second protection block 22 will abut against the first abutting elastic arm 416 and the second abutting elastic arm 426, respectively, so that the first abutting elastic arm 416 and the second abutting elastic arm 426 undergo elastic deformation. When the tongue plate 301 is withdrawn from the receiving slot 101, the first abutting elastic arm 416 and the second abutting elastic arm 426 provide a restoring force, causing the first protection block 21 and the second protection block 22 move to the initial state.

The electrical connector 100 includes an elastic element. The elastic element is configured to abut against the first protection block 21 and the second protection block 22 to provide the restoring force to the first protection block 21 and the second protection block 22. In the illustrated embodiment of the present disclosure, the elastic element includes the first abutting elastic arm 416 and the second abutting elastic arm 426. The first abutting elastic arm 416 is integrally provided with the first ground sheet 41. The second abutting elastic arm 426 is integrally provided with the second ground sheet 42. Of course, it is understandable to those skilled in the art that the elastic element can also be a separate part and is provided on the first housing 11 and/or the second housing 12. As long as the elastic element is elastically deformable to provide a restoring force to the first protection block 21 and the second protection block 22, this will not be described in detail in the present disclosure.

Preferably, in the illustrated embodiment of the present disclosure, no matter what state the first protection block 21 and the second protection block 22 are in, the first distal end portion 3102 and the second distal end portion 3202 are always located in the first receiving groove 211 and the second receiving groove 221, respectively. In other words, no matter what state they are in, the first protection block 21 and the second protection block 22 can protect the first distal end portion 3102 and the second distal end portion 3202. In addition, the first protection block 21 and the second protection block 22 have no linkage relationship with the first conductive terminal 31 and the second conductive terminal 32. That is, the movement of the first protection block 21 and the second protection block 22 will not affect the first conductive terminal 31 and the second conductive terminal 32.

Compared with the prior art, the first tail portion 313 of the first conductive terminal 31 is electrically connected to the first cable 51, and the second tail portion 323 of the second conductive terminal 32 is electrically connected to the second cable 52, which facilitates high-speed signal transmission through the first cable 51 and the second cable 52, thereby being suitable for meeting high-speed signal transmission requirements. Besides, the electrical connector 100 of the present disclosure is provided with the first housing 11 and the second housing 12. The first conductive terminals 31 are not in contact with the first housing 11. The second conductive terminals 32 are not in contact with the second housing 12. The first housing 11 of the first module M1 and the second housing 12 of the second module M2 are separately arranged and fixed together to jointly form the receiving slot 101. With this arrangement, the present disclosure improves the shielding effect on the first conductive terminals 31 and the second conductive terminals 32, and improves the quality of signal transmission. In addition, the electrical connector 100 includes the first protection block 21. The first protection block 21 is configured to be abutted against by the mating module 300 when the mating module 300 is inserted into the first receiving slot 101a, so as to move away from the first receiving slot 101a in the first mounting opening 1123. With this arrangement, on the one hand, the resonance can be improved by shortening the length of the first distal end portion 3102 and the quality of signal transmission can be improved. On the other hand, the provision of the first protection block 21 reduces the risk that the first distal end portion 3102 is easily damaged by foreign objects after its length is shortened, thereby improving reliability. The second protection block 22 is configured to be abutted against by the mating module 300 when the mating module 300 is inserted into the second receiving slot 101b, so as to move away from the second receiving slot 101b in the second mounting opening 1223. With this arrangement, on the one hand, the resonance can be improved by shortening the length of the second distal end portion 3202 and the quality of signal transmission can be improved. On the other hand, the provision of the second protection block 22 reduces the risk that the second distal end portion 3202 is easily damaged by foreign objects after its length is shortened, thereby improving reliability.

The above embodiments are only used to illustrate the present disclosure and not to limit the technical solutions described in the present disclosure. The understanding of this specification should be based on those skilled in the art. Descriptions of directions, although they have been described in detail in the above-mentioned embodiments of the present disclosure, those skilled in the art should understand that modifications or equivalent substitutions can still be made to the application, and all technical solutions and improvements that do not depart from the spirit and scope of the application should be covered by the claims of the application.

What is claimed is:

1. An electrical connector, comprising:
a first housing, the first housing defining a first receiving slot, a first terminal module accommodating slot and a first mounting opening located at one end of the first terminal module accommodating slot; the first mounting opening being in communication with the first receiving slot; the first receiving slot being configured to at least partially receive a mating module;
a first terminal module, the first terminal module being at least partially disposed in the first terminal module accommodating slot, the first terminal module comprising a plurality of first conductive terminals, each first conductive terminal comprising a first elastic contact arm, the first elastic contact arm comprising a first contact portion protruding into the first receiving slot and a first distal end portion extending from the first contact portion; the first contact portion being configured to contact the mating module; and
a first protection block, the first protection block being at least partially disposed in the first mounting opening, the first protection block defining a first receiving groove in which the first distal end portion of the first conductive terminal is located;
wherein the first protection block is configured to be abutted against by the mating module after the mating module is inserted into the first receiving slot, so as to move away from the first receiving slot in the first mounting opening.

2. The electrical connector according to claim 1, wherein the first protection block comprises a first guide surface exposed in the first receiving slot, and the first guide surface is configured to guide the mating module to be inserted into the first receiving slot.

3. The electrical connector according to claim 2, wherein the first guide surface is a first inclined surface.

4. The electrical connector according to claim 2, wherein the first receiving groove extends through the first guide surface.

5. The electrical connector according to claim 1, wherein the first receiving slot extends along a first direction;
the first protection block is movable along a second direction perpendicular to the first direction.

6. The electrical connector according to claim 1, further comprising an elastic element which is configured to abut against the first protection block to provide a restoring force to the first protection block.

7. The electrical connector according to claim 6, further comprising a first ground sheet fixed to the first housing; the first ground sheet comprising a first abutting elastic arm that abuts against the first protection block; the elastic element comprising the first abutting elastic arm.

8. The electrical connector according to claim 7, wherein the first protection block defines a first notch to receive the first abutting elastic arm.

9. The electrical connector according to claim 7, wherein the first ground sheet comprises a first mounting plate, a second mounting plate opposite to the first mounting plate, and a first connecting plate connecting one side of the first mounting plate and one side of the second mounting plate; the first abutting elastic arm is integrally stamped from the first mounting plate; the second mounting plate comprises a first grounding elastic arm protruding into the first receiving slot; the first connecting plate at least partially shields the first protection block.

10. The electrical connector according to claim 1, wherein the first housing is a first conductive housing, and the first protection block is a first insulating protection block.

11. The electrical connector according to claim 1, wherein the electrical connector comprises a first module and a second module; the first module comprises the first housing, the first terminal module and the first protection block;
the second module comprises:
a second housing, the second housing comprises a second receiving slot, a second terminal module accommodating slot, and a second mounting opening located at one end of the second terminal module accommodating slot; the second mounting opening is in communication with the second receiving slot; the second receiving slot is configured to at least partially receive the mating module;
a second terminal module, the second terminal module is at least partially disposed in the second terminal module accommodating slot; the second terminal module comprises a plurality of second conductive terminals; each second conductive terminal comprises a second elastic contact arm; the second elastic contact arm comprises a second contact portion protruding into the second receiving slot and a second distal end portion extending from the second contact portion; the second contact portion is configured to contact the mating module; and
a second protection block, the second protection block is at least partially disposed in the second mounting opening; the second protection block defines a second receiving groove in which the second distal end portion of the second conductive terminal is located;
wherein the second protection block is configured to be abutted against by the mating module after the mating module is inserted into the second receiving slot, so as to move away from the second receiving slot in the second mounting opening.

12. The electrical connector according to claim 11, wherein the first housing of the first module and the second housing of the second module are separately provided and fixed together; the first receiving slot and the second receiving slot jointly form a receiving slot which is configured to at least partially receive the mating module along the first direction; both the first contact portion and the second contact portion protrude into the receiving slot.

13. The electrical connector according to claim 11, wherein the second protection block comprises a second guide surface exposed in the second receiving slot; the first guide surface and the second guide surface jointly form a bell mouth to guide the mating module to be inserted into the receiving slot.

14. The electrical connector according to claim 13, wherein the second guide surface is a second inclined surface through which the second receiving groove extends.

15. The electrical connector according to claim 11, wherein the second protection block is movable in a second direction perpendicular to the first direction.

16. The electrical connector according to claim 11, wherein the second module further comprises a second ground sheet fixed to the second housing; the second ground sheet comprises a second abutting elastic arm that abuts against the second protection block; the second abutting elastic arm is configured to provide a restoring force to the second protection block.

17. The electrical connector according to claim 16, wherein the second protection block defines a second notch to receive the second abutting elastic arm.

18. The electrical connector according to claim 16, wherein the second ground sheet comprises a third mounting plate, a fourth mounting plate opposite to the third mounting plate, and a second connecting plate connecting one side of the third mounting plate and one side of the fourth mounting plate; the second abutting elastic arm is integrally stamped from the third mounting plate; the fourth mounting plate comprises a second grounding elastic arm protruding into the second receiving slot; the second connecting plate at least partially shields the second protection block.

19. The electrical connector according to claim 11, wherein the second housing is a second conductive housing, and the second protection block is a second insulating protection block.

20. The electrical connector according to claim 11, wherein the first module further comprises a plurality of first cables connected to the plurality of first conductive terminals;
the second module further comprises a plurality of second cables connected to the plurality of second conductive terminals.
